(19) United States
(12) Patent Application Publication
(10) Pub. No.: US 2011/0100329 A1
(43) Pub. Date: May 5, 2011

(54) METHOD FOR DETERMINING A FUEL TEMPERATURE IN AN INJECTION SYSTEM

(76) Inventor: Hui Li, Regensburg (DE)

(21) Appl. No.: 13/000,752

(22) PCT Filed: Jun. 5, 2009
(86) PCT No.: PCT/EP2009/056923

§ 371 Date: Dec. 22, 2010

(30) Foreign Application Priority Data
Jul. 3, 2008 (DE) 10 2008 031 535.4

(51) Int. Cl. F02D 41/00; G01K 1/00

(52) U.S. Cl. 123/445; 374/144; 374/E01.001

(57) ABSTRACT

In a method for determining a fuel temperature in an injection system for an internal combustion engine, a modulus of elasticity of the fuel is determined on the basis of a measured parameter, and the fuel temperature is determined on the basis of the modulus of elasticity. In a method for determining a fuel temperature upstream of a forepump of an injection system for an internal combustion engine, the intake air temperature and a fuel pressure in the injection system are determined, and the fuel temperature is determined in accordance with the fuel pressure and the intake air temperature.

### CROSS-REFERENCE TO RELATED APPLICATIONS

This application is a U.S. National Stage Application of International Application No. PCT/EP2009/056923 filed Jun. 5, 2009, which designates the United States of America, and claims priority to German Application No. 10 2008 031 535.4 filed Jul. 3, 2008, the contents of which are hereby incorporated by reference in their entirety.

### TECHNICAL FIELD

The invention relates to method for determining a fuel temperature in an injection system.

### BACKGROUND

In the prior art, various methods for determining the temperature of the fuel in an injection system are known. For example, the fuel temperature is measured at a section of the injection system and, on the basis of the temperature measured, the temperature at another location in the injection system is determined using physical models.

### SUMMARY

According to various embodiments, methods for determining the fuel temperature in an injection system can be provided without having to use a fuel temperature sensor.

According to an embodiment, in a method for determining a fuel temperature in an injection system for an internal combustion engine, a modulus of elasticity of the fuel is determined on the basis of a measured parameter, and the temperature of the fuel being determined on the basis of the modulus of elasticity.

According to a further embodiment, the modulus of elasticity for the fuel in a fuel accumulator can be calculated, a pressure change in the fuel accumulator, the volume of the fuel accumulator and a fuel flow into the fuel accumulator or out of the fuel accumulator being taken into account for calculating the modulus of elasticity. According to a further embodiment, the temperature of the fuel can be determined on the basis of the modulus of elasticity using a graph. According to a further embodiment, the temperature of the fuel upstream of a pre-pump can be determined on the basis of the temperature of the fuel in the fuel accumulator using at least one correction value. According to a further embodiment, the temperature of the fuel in a leakage flow of an injection valve can be calculated on the basis of the temperature of the fuel in the fuel accumulator using at least one correction value. According to a further embodiment, at least one correction value depending on at least one of the following parameters can be used: cooling water temperature, fuel pressure in the fuel accumulator, intake air temperature, vehicle speed, fuel flow into the fuel accumulator and/or fuel flow out of the fuel accumulator.

According to another embodiment, in a method for determining a fuel temperature upstream of a pre-pump in an injection system for an internal combustion engine, the intake air temperature and a fuel pressure in the injection system are determined, and the fuel temperature is determined as a function of the fuel pressure and the intake air temperature.

According to a further embodiment of the above method, a parameter as a function of cold or warm starting of the internal combustion engine can be taken into account. According to a further embodiment of the above method, the pressure in a fuel accumulator can be taken into account. According to a further embodiment of the above method, at least one correction value can be used for determining the fuel temperature as a function of at least one of the following parameters: fill level of a fuel tank, vehicle speed, fuel flow through a fuel accumulator and cooling water temperature.

### BRIEF DESCRIPTION OF THE DRAWINGS

The invention will now be explained in greater detail with reference to the accompanying drawings in which:

FIG. 1 shows a schematic diagram of a fuel injection system,

FIG. 2 shows a graph of fuel temperature versus modulus of elasticity,

FIG. 3 shows a schematic diagram of a method of calculating the fuel temperature upstream of the pre-pump and in the leakage flow of the injection valves,

FIG. 4 shows a schematic diagram of another method of calculating the fuel temperature upstream of the pre-pump,

FIG. 5 shows another schematic diagram illustrating the calculation of the fuel temperature in the fuel rail and in the leakage flow of the injection valves.

### DETAILED DESCRIPTION

An advantage of the methods according to various embodiments is that no fuel temperature sensor is required, which means that the injection system is of inexpensive design. This cost advantage is achieved in one embodiment by ascertaining the modulus of elasticity of the fuel in the injection system on the basis of the fuel pressure and determining the temperature of the fuel on the basis of the modulus of elasticity.

In an alternative embodiment, the advantage is achieved by determining the temperature of the fuel upstream of a pre-pump as a function of the intake air temperature and a fuel pressure in the injection system. Using the two methods described it is possible to determine the fuel temperature in the injection system without a fuel temperature sensor.

In another embodiment, the modulus of elasticity of the fuel in a fuel accumulator is calculated taking into account a pressure change in the fuel accumulator, the volume of the fuel accumulator and a fuel flow through the fuel accumulator. In this way, precise calculation of the modulus of elasticity is possible.

Depending on the embodiment selected, the relationship between the modulus of elasticity and the temperature of the fuel can be charted or tabulated or formulated.

In another embodiment, the temperature of the fuel upstream of the pre-pump is determined using a correction value.

In a further embodiment, the temperature of the fuel in a leakage flow of an injection valve is calculated using a correction value as a function of the temperature of the fuel in the fuel accumulator.

According to the embodiment selected, correction values as a function of at least one of the available parameters are used: cooling water temperature, fuel pressure in the fuel accumulator, intake air temperature, vehicle speed, fuel flow into the fuel accumulator and/or fuel flow out of the fuel accumulator.

In another embodiment, a parameter as a function of cold starting of the internal combustion engine or warm starting of the internal combustion engine is taken into account for determining the fuel temperature, thereby enabling the fuel temperature to be calculated more precisely particularly for calculating the fuel temperature upstream of a pre-pump.

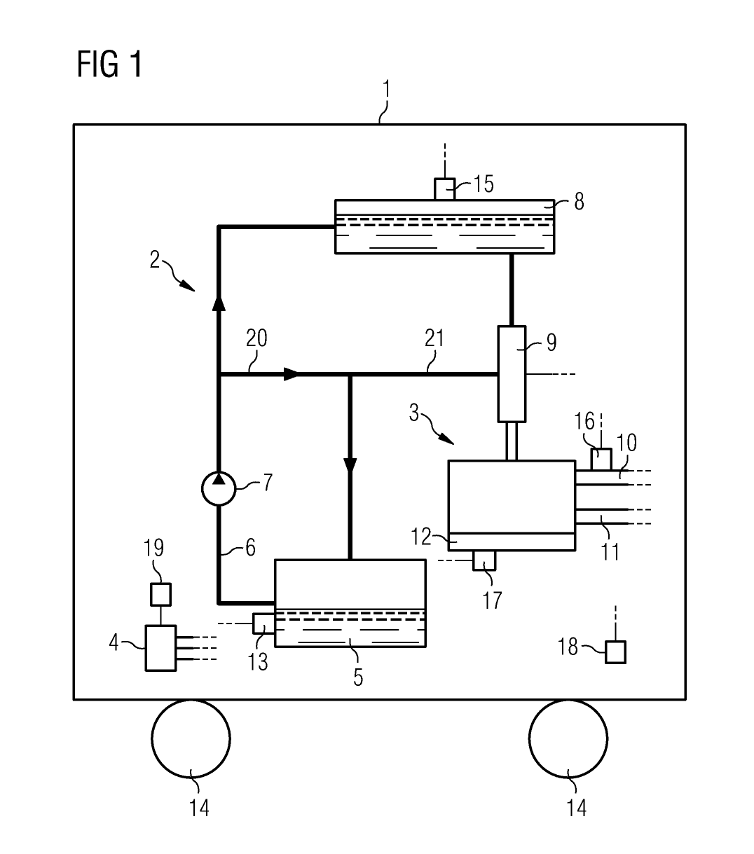

FIG. 1 schematically illustrates a motor vehicle 1 with an injection system 2, having an internal combustion engine 3 which drives the wheels 14. The injection system 2 has a fuel tank 5 and a feed line 6 to a pump 7. The pump 7 has an output connected to a fuel accumulator 8. The pump 7 can be implemented as a high-pressure pump which can produce pressures of up to 2000 bar in the fuel accumulator 8. Injection valves 9 are connected to the fuel accumulator 8 and are supplied with fuel from the fuel accumulator 8. The injection valves 9 are assigned to a combustion chamber of the internal combustion engine 3. The injection valves 9 and the pump 7 are connected to the control unit 4 via control lines.

The internal combustion engine 3 also has an intake tract 10 for sucking in fresh air. In addition, an exhaust tract 11 is provided via which exhaust gases are discharged from the internal combustion engine 3. The internal combustion engine 3 is additionally connected to the wheels 14 via a transmission. The internal combustion engine 3 is also provided with a cooling system 12 containing coolant for cooling the internal combustion engine 3.

On the fuel tank 5, a fill level sensor 13 is provided which is connected to the control unit 4. On the fuel accumulator 8 there is additionally provided a pressure sensor 15 which is connected to the control unit 4. On the intake tract 10 there is also provided an air temperature sensor 16 which is connected to the control unit 4. A coolant temperature sensor 17 is additionally provided which measures the temperature of the coolant in the cooling system 12 and is connected to the control unit 4. A speed sensor 18 is also provided which is likewise connected to the control unit 4. The speed sensor 18 detects the road speed of the vehicle 1 and forwards it to the control unit 4.

In addition, further sensors are provided which are connected to the control unit 4 and which forward operating parameters of the internal combustion engine, such as RPM, torque or a driver command in the form of an accelerator pedal position, to the control unit 4. The control unit 4 is connected to a data memory 19 in which are stored data, tables and control programs with which the pump 7, the injection valves 9 and the internal combustion engine 3, e.g. a throttle valve and/or inlet and outlet valves, are controlled. In this way, in response to a driver command, the torque requested by the driver is provided by the internal combustion engine. This requires that the fuel in the fuel accumulator 8 has a predefined pressure and a desired quantity of fuel is injected at predefined time instants by the injection valves 9.

In addition, a line 20 downstream of the pump 7 and a leakage line 21 from the injection valves 9 lead back to the tank 5. Leakage from the pump 7 or fuel at excessively high pressure in the fuel accumulator 8, for example, is drained to the fuel tank 5 via the line 20. Leakage from the injection valves 9 is returned to the fuel tank 5 via the leakage line 21.

For precise injection of a defined quantity of fuel, particularly to keep within low pollutant limits, it is necessary to know the fuel temperature at the injection valves 9. It is also advantageous to know the fuel temperature upstream of the pump 7 or in the fuel accumulator 8. The method described determines the fuel temperature at various points of the injection system without using a fuel temperature sensor.

In a first embodiment, the fuel temperature is calculated using a determined modulus of elasticity of the fuel. For this purpose the following physical relation is used:

(d(PFU)/dt)=(E/(V*ΔQ),

where PFU is the fuel pressure in the fuel accumulator 8, E the compressibility modulus (modulus of elasticity) of the fuel, V the volume of the fuel in the fuel accumulator and ΔQ the volume of fuel supplied to the fuel accumulator 8. Denoted by (d(PFU)/dt) is the time derivative of the fuel pressure as a function of time. The fuel pressure PFU is measured using the pressure sensor 15, the volume of the fuel accumulator 8 is known and the volume inflow is also known. For the volume, the volume of the line from the pump 7 to the fuel accumulator 8 and the line from the fuel accumulator to the injection valves 9 is preferably also taken into account. In this way the modulus of elasticity can be calculated. The modulus of elasticity constitutes a pressure- and temperature-dependent property of the fuel. If the modulus of elasticity and the pressure are known, the temperature of the fuel can be calculated.

In an exemplary embodiment, the fuel pressure in the fuel accumulator 8 is measured using the pressure sensor 15 and forwarded to the control unit 4. The volume of the fuel accumulator is stored in the data memory 19. The control unit 4 also controls the pump 7 and the injection valves 9 so that the volume of fuel supplied to the fuel accumulator 8 is known in the control unit 4. Should the pump 7 only depend on the RPM of the internal combustion engine, the control unit 4 can determine the supplied fuel volume via the RPM of the internal combustion engine and via the known delivery volume of the pump 7. The control unit now measures, at two consecutive instants, the change over time of the fuel pressure and also the volume of fuel supplied to the fuel accumulator and calculates therefrom the modulus of elasticity using the following formula:

E=(d(PFU)/dt)*(V/ΔQ).

On the basis of the known modulus of elasticity, the control unit 4 can now determine the fuel temperature in the form of formulas or tables in which is stored the modulus of elasticity as a function of the pressure and temperature.

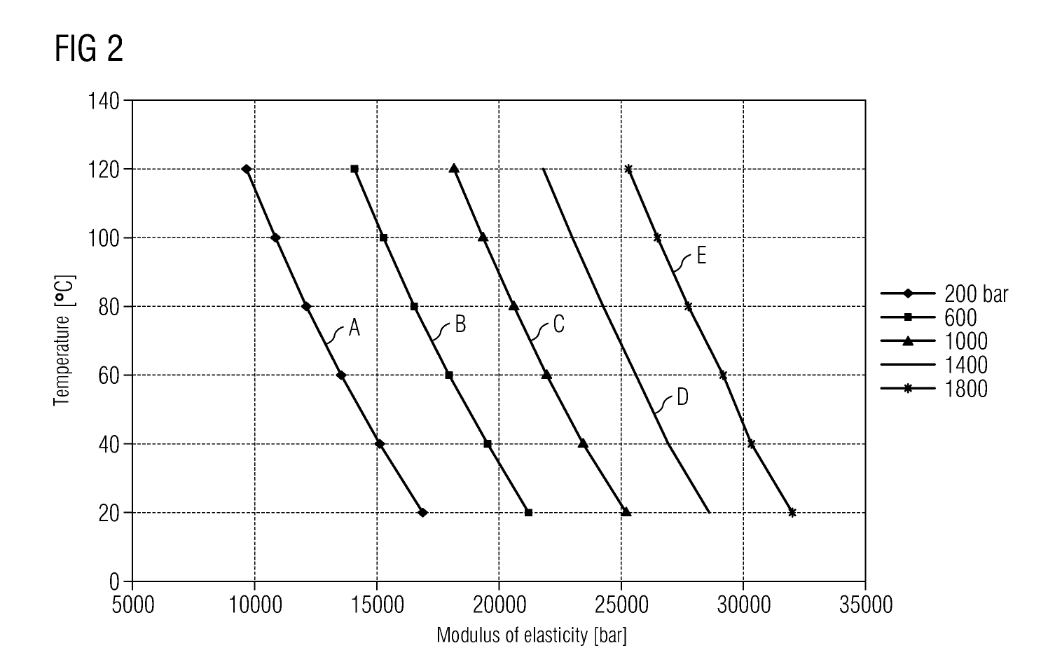

FIG. 2 is a graph showing modulus of elasticity versus temperature for different fuel pressures, the temperature being plotted on the y-axis in degrees Celsius and the modulus of elasticity on the x-axis in bar. On the graph, a first line A indicates the modulus of elasticity at 200 bar fuel pressure, a second line B the modulus of elasticity for a pressure of 600 bar, a third line C for a fuel pressure of 1000 bar, a fourth line D for a fuel pressure of 1400 bar and a fifth line E for a fuel pressure of 1800 bar. Instead of the individual lines, engine maps can also be provided for representing the modulus of elasticity as a function of fuel pressure and temperature.

For example, if the control unit 4 now determines a modulus of elasticity of 15000 bar for a fuel pressure of 200 bar in the fuel accumulator 8, the control unit 4 can determine, on the basis of this value and on the basis of the first line A shown in FIG. 2, a temperature of 40° C.

It is therefore possible in this way to determine the fuel temperature in the fuel accumulator 8 independently of a fuel temperature sensor.

The methods described in the Figures are implemented by the control unit 4.

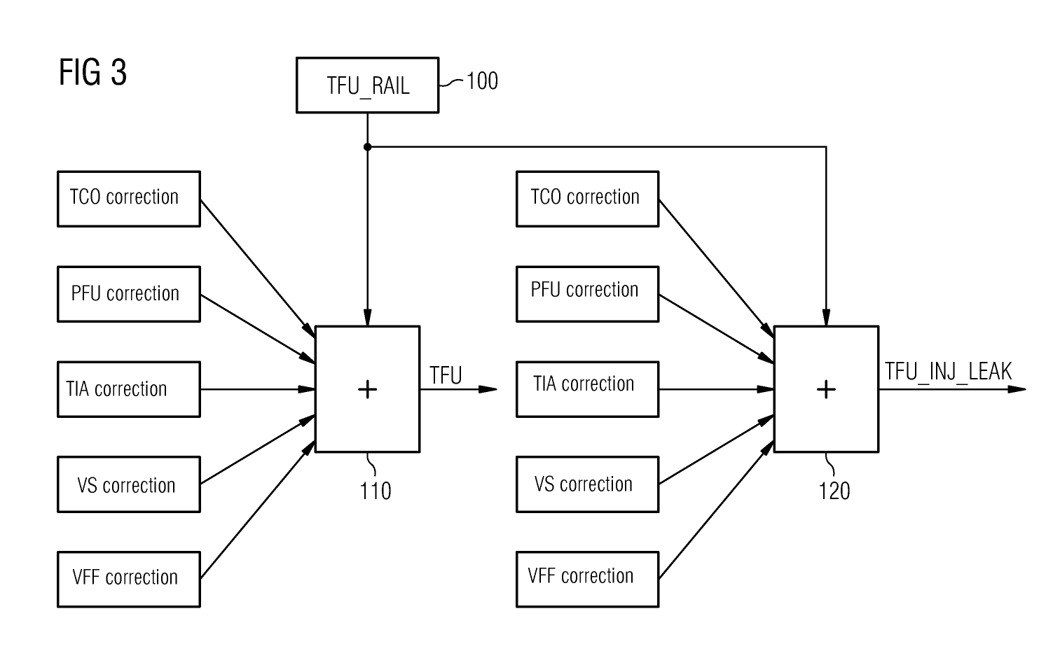

FIG. 3 schematically illustrates the setup for a method whereby the control unit 4 can calculate the fuel pressure in the feed line 6 and at the injection valve 9, said control unit 4 taking the fuel temperature in the fuel accumulator 8, calculated using the modulus of elasticity, as the starting point at program point 100. The fuel temperature in the fuel accumulator constitutes a base value for calculating the fuel temperature in the feed line 6 upstream of the pump 7 and in the leakage flow in the leakage line 21.

To calculate the temperature value in the feed line 6, tables and/or engine maps are used which take into account the cooling water temperature TCO which is forwarded to the control unit 4 using the coolant temperature sensor 17, the fuel pressure PFU in the fuel accumulator 8 which is measured by the pressure sensor 15, the temperature TIA of the intake air which is measured in the intake tract 11 by the air temperature sensor 16 and forwarded to the control unit 4, the vehicle speed VS which is measured using the speed sensor 18 and forwarded to the control unit 4, and the volume flow of fuel through the feed line 6. For this purpose, the corresponding measured values are acquired and correction values are determined using the assigned tables and/or engine maps with which, in a calculation block 110, the fuel temperature TFU in the feed line 6 is calculated on the basis of the fuel temperature determined using the modulus of elasticity.

In the same way, the fuel temperature TFU_INJ_LEAK in the leakage flow is calculated using a second calculation block 120 on the basis of the fuel temperature in the fuel accumulator 8 calculated from the modulus of elasticity, and as a function of the cooling water temperature TCO, the fuel pressure PFU in the fuel accumulator 8, the intake air temperature TIA, the vehicle speed VS and the volume flow rate VFF of fuel through the injection valve. For this purpose different tables and/or engine maps from those for calculating the fuel pressure in the feed line 6 are used.

In this way the fuel pressure in the feed line 6 and the fuel pressure in the leakage flow of the leakage line 21 of the injection valves 9 can be determined using the modulus of elasticity.

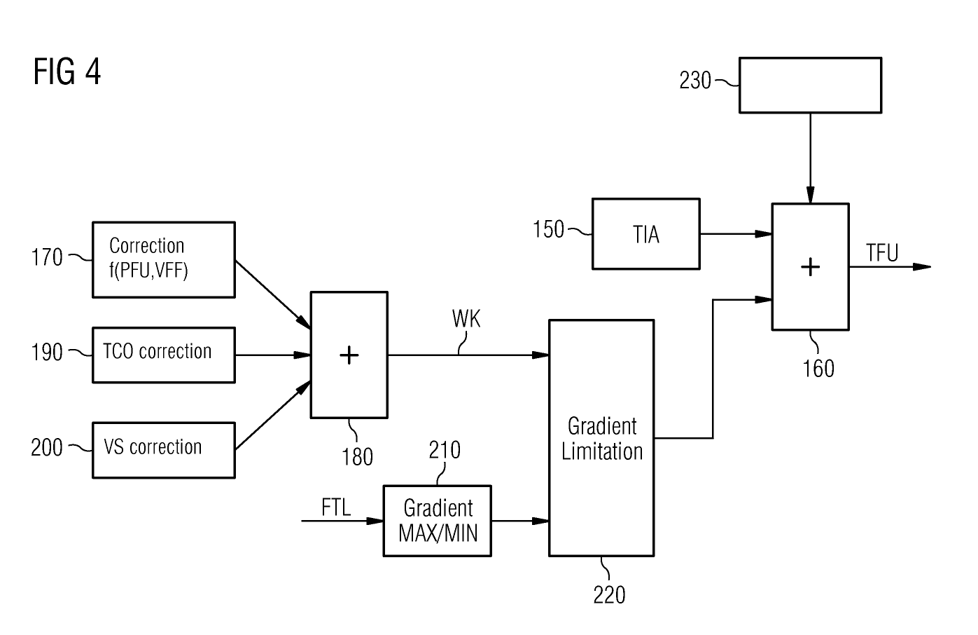

FIG. 4 shows an alternative method for calculating the fuel temperature TFU in the feed line 6. For this purpose, in a first calculation step 150, the intake air temperature TIA is measured by the air temperature sensor 16 and forwarded to a first calculation block 160. In addition, in a program block 170, a correction value is determined as a function of a function involving the parameters fuel pressure PFU in the fuel accumulator and fuel flow rate VFF through the feed line 6 and forwarded to a second calculation unit 180. A correction value is also obtained as a function of the cooling water temperature TCO in a program block 190 and forwarded to the second calculation block 180. A correction value is additionally acquired as a function of the vehicle speed VS in a program block 200 and forwarded to the second calculation unit 180.

In addition, the fill level FTL of the fuel tank 5 is determined using the level sensor 13. On the basis of the fill level FTL of the tank 5, a maximum or minimum gradient for a fuel temperature change is determined in a program block 210.

The maximum or minimum gradient is forwarded to a third calculation block 220. The second calculation unit 180 determines from the supplied correction values another correction value WK which is fed to the calculation block 220. The third calculation block 220 determines a limit of the gradient for the fuel temperature change and passes it on to the other calculation block 160. The calculation block 160 determines the fuel temperature TFU in the feed line 6 from the intake air temperature TIA, from an additional parameter which takes cold or warm starting into account and which is provided by a calculation block 230, and from the limiting value for the gradient which is provided by the calculation block 220.

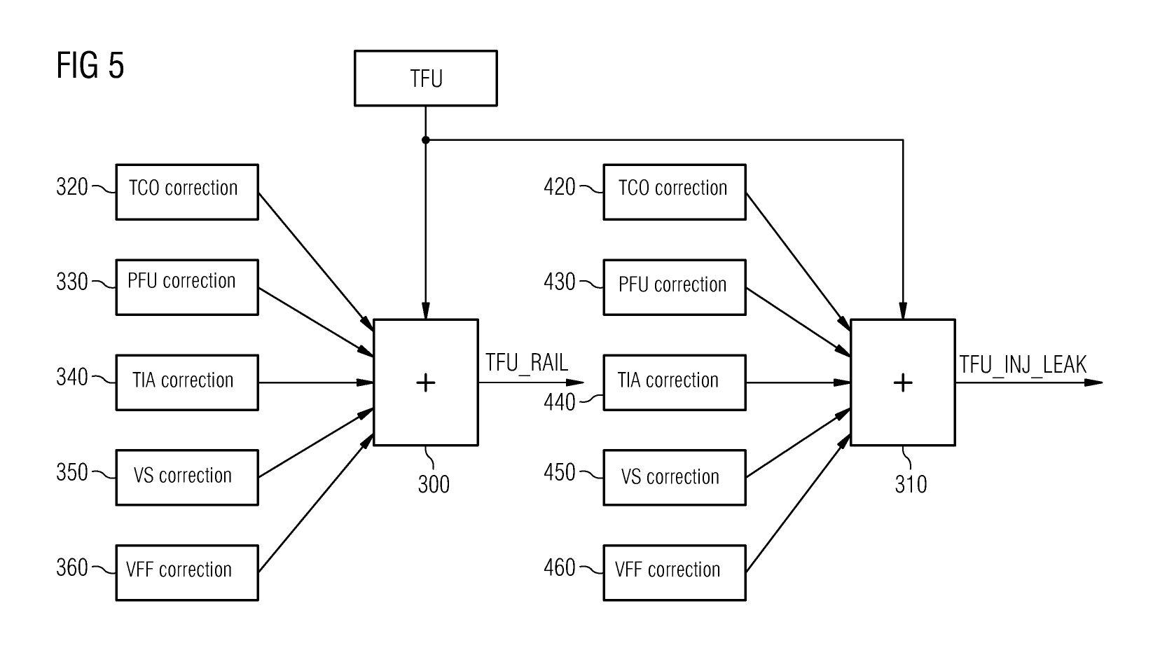

On the basis of the ascertained fuel temperature TFU and the feed line 6, the temperature in the fuel accumulator 8 TFU_RAIL and the temperature in the leakage flow of the injection valves 9 TFU_INJ_LEAK can be calculated using the calculation model shown in FIG. 5. For this purpose the fuel temperature TFU is made available to a first calculation block 300 and a second calculation block 310 as a base value. In addition, a first correction value 320 as a function of the cooling water temperature TCO, a second correction value 330 as a function of the fuel pressure in the fuel accumulator 8, a third correction value as a function of the intake air temperature TIA, a fourth correction value 350 as a function of the vehicle speed VS and a fifth correction value as a function of the flow of fuel through the fuel accumulator 8 are made available to the first calculation block 300. The correction values are determined using formulas and/or tables and/or engine maps. The first calculation block 300 adds the supplied correction values to the fuel temperature TFU in the feed line 6 and determines in this way the fuel temperature TFU_RAIL in the fuel accumulator 8.

In addition, a tenth correction value 420 as a function of the cooling water temperature TCO, an eleventh correction value 430 as a function of the fuel pressure PFU in the fuel accumulator, a twelfth correction value 440 as a function of the intake air temperature TIA, a thirteenth correction value 450 as a function of the vehicle speed VS and a fourteenth correction value 460 as a function of the fuel flow rate through the injection valves 9 are made available to the second calculation block 310. Tables and/or engine maps and/or graphs are used to determine the correction values. The engine maps, graphs and formulas for the tenth to 15th correction value can be different from those for the first to fifth correction value. The second calculation block 310 adds the correction values to the fuel temperature TFU upstream of the pump 7 and determines thereby the fuel temperature in the leakage flow in the leakage line 21 of the injection valves 9.

With this method also, it is possible to determine the temperature in the feed line 6, in the fuel accumulator 8 and in the leakage flow of the injection valves 9 without using a fuel temperature sensor.

Test have shown that, for an accuracy of +−10° C., it is necessary to determine the modulus of elasticity with an accuracy of +−2.5% in the 1800 bar fuel pressure range and with an accuracy of +−6.7% in the 200 bar fuel pressure range.

The formulas, engine maps and/or graphs for calculating the corrections are established using physical models or experimentally.

What is claimed is:

1. A method for determining a fuel temperature in an injection system for an internal combustion engine, comprising: determining a modulus of elasticity of the fuel on the basis of a measured parameter, and
determining the temperature of the fuel on the basis of the modulus of elasticity.

2. The method according to claim 1, wherein the modulus of elasticity for the fuel in a fuel accumulator is calculated, a pressure change in the fuel accumulator, the volume of the fuel accumulator and a fuel flow into the fuel accumulator or out of the fuel accumulator being taken into account for calculating the modulus of elasticity.

3. The method according to claim 1, wherein the temperature of the fuel is determined on the basis of the modulus of elasticity using a graph.

4. The method according to claim 2, wherein the temperature of the fuel upstream of a pre-pump is determined on the basis of the temperature of the fuel in the fuel accumulator using at least one correction value.

5. The method according to claim 2, wherein the temperature of the fuel in a leakage flow of an injection valve is calculated on the basis of the temperature of the fuel in the fuel accumulator using at least one correction value.

6. The method according to claim 4, wherein at least one correction value depending on at least one of the following parameters is used selected from the parameter group consisting of: cooling water temperature, fuel pressure in the fuel accumulator, intake air temperature, vehicle speed, fuel flow into the fuel accumulator, and fuel flow out of the fuel accumulator.

7. A method for determining a fuel temperature upstream of a pre-pump in an injection system for an internal combustion engine, comprising:
determining the intake air temperature and a fuel pressure in the injection system, and
determining the fuel temperature as a function of the fuel pressure and the intake air temperature.

8. The method according to claim 7, wherein a parameter as a function of cold or warm starting of the internal combustion engine is taken into account.

9. The method according to claim 7, wherein the pressure in a fuel accumulator is taken into account.

10. The method according to claim 7, wherein at least one correction value is used for determining the fuel temperature as a function of at least one of the following parameters: fill level of a fuel tank, vehicle speed, fuel flow through a fuel accumulator and cooling water temperature.

11. A motor vehicle with an internal combustion engine, comprising an injection system comprising:
a fuel tank,
a fuel pump having an output connected to a fuel accumulator,
a feed line coupled with the fuel pump,
injection valves connected to the fuel accumulator and being supplied with fuel from the fuel accumulator,
a control unit coupled with the injection valves, the fuel pump and a plurality of sensors via control lines, wherein the control unit is operable to determine a modulus of elasticity of the fuel on the basis of a measured parameter from said sensors, and to determine the temperature of the fuel on the basis of the modulus of elasticity.

12. The motor vehicle according to claim 11, wherein the internal combustion engine is also provided with a cooling system containing coolant for cooling the internal combustion engine.

13. The motor vehicle according to claim 11, wherein the plurality of sensors comprise at least one of a fill level sensor, a pressure sensor, an air temperature sensor, a coolant temperature sensor, a speed sensor, an RPM sensor, a torque sensor, and an accelerator pedal position sensor.

14. The motor vehicle according to claim 11, wherein the control unit is connected to a data memory in which are stored data, tables and control programs with which the pump, the injection valves and the internal combustion engine are controlled.

15. The motor vehicle according to claim 14, wherein the internal combustion engine is controlled by said control unit through at least one of a throttle valve and inlet and outlet valves.

16. The motor vehicle according to claim 11, comprising a line downstream of the fuel pump and a leakage line from the injection valves leading back to the fuel tank.

17. The motor vehicle according to claim 11, wherein the modulus of elasticity for the fuel in a fuel accumulator is calculated, a pressure change in the fuel accumulator, the volume of the fuel accumulator and a fuel flow into the fuel accumulator or out of the fuel accumulator being taken into account for calculating the modulus of elasticity.

18. The motor vehicle according to claim 11, wherein the temperature of the fuel is determined on the basis of the modulus of elasticity using a graph.

19. The motor vehicle according to claim 17, wherein the temperature of the fuel upstream of a pre-pump is determined on the basis of the temperature of the fuel in the fuel accumulator using at least one correction value.

20. The motor vehicle according to claim 17, wherein the temperature of the fuel in a leakage flow of an injection valve is calculated on the basis of the temperature of the fuel in the fuel accumulator using at least one correction value.
